(19) United States
(12) Patent Application Publication
(10) Pub. No.: US 2018/0357413 A1
(43) Pub. Date: Dec. 13, 2018

(54) Methods and Systems for the Active Defense of a Computing System Against Malware

(71) Applicant: Paul A. Rivera, San Antonio, TX (US)

(72) Inventor: Paul A. Rivera, San Antonio, TX (US)

(21) Appl. No.: 15/995,088

(22) Filed: May 31, 2018

Related U.S. Application Data
(60) Provisional application No. 62/513,263, filed on May 31, 2017.

(51) Int. Cl. G06F 21/54; G06F 21/56; G06F 21/57

(52) U.S. Cl. CPC G06F 21/54; G06F 21/57; G06F 21/566

(57) ABSTRACT

Methods and systems for defending a computing system against malware are disclosed, including (a) determining which mode an active defense system (ADS) is enabled; (b) if passive mode, then log API calls; determining whether an exploit has executed on the computing system; if exploit has not executed, then continue logging API calls; and if exploit has executed, then using the ADS to analyze the log to determine API chain which resulted in the exploit and creating a new active defense API chain rule; and (c) if active mode, then monitoring process's API calls; determining whether the process's API calls match one of known active defense API chain rules; if API calls do not match, then continue monitoring the process's API calls; and if API calls do match, then using the ADS to deny the process's API call and/or kill the process. Other embodiments are described and claimed.

### I. CROSS REFERENCE TO RELATED APPLICATIONS

This application claims the benefit of the filing date of U.S. Provisional Patent Application Ser. No. 62/513,263, filed on May 31, 2017, entitled “Methods and Systems for the Active Defense of a Computing System Against Malware,” the entire disclosure of which is hereby incorporated by reference into the present disclosure.

### II. BACKGROUND

The invention relates generally to defense of computing systems against malware. More particularly, the invention relates to an innovative method and system for characterizing malicious behavior as a collection of Application Programming Interface (API) calls that are indicative of malware.

### III. SUMMARY

In one respect, disclosed is a method for defending a computing system against malware, the method comprising: (a) determining which mode an active defense system is enabled; (b) if the determination made in step (a), above, is that the active defense system is set to a passive mode, then using the active defense system to log API calls; (b)(i) determining whether an exploit has executed on the computing system; (b)(ii) if the determination made in step (b)(i), above, is that the exploit has not executed on the computing system, then continue using the active defense system to log API calls; and (b)(iii) if the determination made in step (b)(i), above, is that the exploit has executed on the computing system, then using the active defense system to analyze the log of API calls to determine API chain which resulted in the exploit and creating a new active defense API chain rule from the API chain which resulted in the exploit; and (c) if the determination made in step (a), above, is that the active defense system is set to an active mode, then using the active defense system to monitor process's API calls; (c)(i) determining whether the process's API calls match one of known active defense API chain rules; (c)(ii) if the determination made in step (c)(i), above, is that the process's API calls do not match one of the known active defense API chain rules, then continue using the active defense system to monitor the process's API calls; and (c)(iii) if the determination made in step (c)(i), above, is that the process's API calls do match one of the known active defense API chain rules, then using the active defense system to deny the process's API call and/or kill the process whose API calls match one of the known active defense API chain rules.

In another respect, disclosed is a method for defending a computing system against malware, the method comprising: (a) using an active defense system to log API calls; (b) determining whether an exploit has executed on the computing system; (c) if the determination made in step (b), above, is that the exploit has not executed on the computing system, then continue using the active defense system to log API calls; and (d) if the determination made in step (b), above, is that the exploit has executed on the computing system, then using the active defense system to analyze the log of API calls to determine API chain which resulted in the exploit and creating a new active defense API chain rule from the API chain which resulted in the exploit.

In another respect, disclosed is a method for defending a computing system against malware, the method comprising: (a) using the active defense system to monitor process's API calls; (b) determining whether the process's API calls match one of known active defense API chain rules; (c) if the determination made in step (b), above, is that the process's API calls do not match one of the known active defense API chain rules, then continue using the active defense system to monitor the process's API calls; and (d) if the determination made in step (b), above, is that the process's API calls do match one of the known active defense API chain rules, then using the active defense system to deny the process's API call of the API and/or kill the process whose API calls match one of the known active defense API chain rules.

In yet another respect, disclosed is a non-transitory computer-readable storage medium containing instructions that if executed enables a computing system to: (a) determine which mode an active defense system is enabled; (b) if the determination made in step (a), above, is that the active defense system is set to a passive mode, then use the active defense system to log API calls; (b)(i) determine whether an exploit has executed on the computing system; (b)(ii) if the determination made in step (b)(i), above, is that the exploit has not executed on the computing system, then continue using the active defense system to log API calls; and (b)(iii) if the determination made in step (b)(i), above, is that the exploit has executed on the computing system, then use the active defense system to analyze the log of API calls to determine API chain which resulted in the exploit and create a new active defense API chain rule from the API chain which resulted in the exploit; and (c) if the determination made in step (a), above, is that the active defense system is set to an active mode, then use the active defense system to monitor process's API calls; (c)(i) determine whether the process's API calls match one of known active defense API chain rules; (c)(ii) if the determination made in step (c)(i), above, is that the process's API calls do not match one of the known active defense API chain rules, then continue using the active defense system to monitor the process's API calls; and (c)(iii) if the determination made in step (c)(i), above, is that the process's API calls do match one of the known active defense API chain rules, then use the active defense system to deny the process's API call and/or kill the process whose API calls match one of the known active defense API chain rules.

In another respect, disclosed is a non-transitory computer-readable storage medium containing instructions that if executed enables a computing system to: (a) use the active defense system to log API calls; (b) determine whether an exploit has executed on the computing system; (c) if the determination made in step (b), above, is that the exploit has not executed on the computing system, then continue using the active defense system to log API calls; and (d) if the determination made in step (b), above, is that the exploit has executed on the computing system, then use the active defense system to analyze the log of API calls to determine API chain which resulted in the exploit and create a new active defense API chain rule from the API chain which resulted in the exploit.

In another respect, disclosed is a non-transitory computer-readable storage medium containing instructions that if executed enables a computing system to: (a) use the active defense system to monitor process's API calls; (b) determine whether the process's API calls match one of known active defense API chain rules; (c) if the determination made in step (b), above, is that the process's API calls do not match one of the known active defense API chain rules, then continue using the active defense system to monitor the process's API calls; and (d) if the determination made in step (b), above, is that the process's API calls do match one of the known active defense API chain rules, then use the active defense system to deny the process's API call and/or kill the process whose API calls match one of the known active defense API chain rules.

In yet another respect, disclosed is a computing system comprising: at least one storage device containing instructions that if executed enables the computing system to: (a) determine which mode an active defense system is enabled; (b) if the determination made in step (a), above, is that the active defense system is set to a passive mode, then use the active defense system to log API calls; (b)(i) determine whether an exploit has executed on the computing system; (b)(ii) if the determination made in step (b)(i), above, is that the exploit has not executed on the computing system, then continue using the active defense system to log API calls; and (b)(iii) if the determination made in step (b)(i), above, is that the exploit has executed on the computing system, then use the active defense system to analyze the log of API calls to determine API chain which resulted in the exploit and create a new active defense API chain rule from the API chain which resulted in the exploit; and (c) if the determination made in step (a), above, is that the active defense system is set to an active mode, then use the active defense system to monitor process's API calls; (c)(i) determine whether the process's API calls match one of known active defense API chain rules; (c)(ii) if the determination made in step (c)(i), above, is that the process's API calls do not match one of the known active defense API chain rules, then continue using the active defense system to monitor the process's API calls; and (c)(iii) if the determination made in step (c)(i), above, is that the process's API calls do match one of the known active defense API chain rules, then use the active defense system to deny the process's API call and/or kill the process whose API calls match one of the known active defense API chain rules.

In another respect, disclosed is a computing system comprising: at least one storage device containing instructions that if executed enables the computing system to: (a) use the active defense system to log API calls; (b) determine whether an exploit has executed on the computing system; (c) if the determination made in step (b), above, is that the exploit has not executed on the computing system, then continue using the active defense system to log API calls; and (d) if the determination made in step (b), above, is that the exploit has executed on the computing system, then use the active defense system to analyze the log of API calls to determine API chain which resulted in the exploit and create a new active defense API chain rule from the API chain which resulted in the exploit.

In another respect, disclosed is a computing system comprising: at least one storage device containing instructions that if executed enables the computing system to: (a) use the active defense system to monitor process's API calls; (b) determine whether the process's API calls match one of known active defense API chain rules; (c) if the determination made in step (b), above, is that the process's API calls do not match one of the known active defense API chain rules, then continue using the active defense system to monitor the process's API calls; and (d) if the determination made in step (b), above, is that the process's API calls do match one of the known active defense API chain rules, then use the active defense system to deny the process's API call and/or kill the process whose API calls match one of the known active defense API chain rules.

Numerous additional embodiments are also possible.

### IV. BRIEF DESCRIPTION OF THE DRAWINGS

Other objects and advantages of the invention may become apparent upon reading the detailed description and upon reference to the accompanying drawings.

FIG. 1 is a block diagram of an active defense system of a computing system against malware, in accordance with some embodiments.

FIG. 2 is a block diagram of an inspection of an API call of the active defense system of the computing system, in accordance with some embodiments.

FIG. 3 is a flow diagram illustrating a method for the active defense of a computing system against malware, in accordance with some embodiments.

FIG. 4 is a block diagram of an apparatus for the active defense of a computing system against malware, in accordance with some embodiments.

While the invention is subject to various modifications and alternative forms, specific embodiments thereof are shown by way of example in the drawings and the accompanying detailed description. It should be understood, however, that the drawings and detailed description are not intended to limit the invention to the particular embodiments. This disclosure is instead intended to cover all modifications, equivalents, and alternatives falling within the scope of the present invention as defined by the appended claims.

### V. DETAILED DESCRIPTION

One or more embodiments of the invention are described below. It should be noted that these and any other embodiments are exemplary and are intended to be illustrative of the invention rather than limiting. While the invention is widely applicable to different types of systems, it is impossible to include all of the possible embodiments and contexts of the invention in this disclosure. Upon reading this disclosure, many alternative embodiments of the present invention will be apparent to persons of ordinary skill in the art.

Breaches involving extortion tactics and theft of currency or identities from financial institutions is a lucrative criminal enterprise and continues to increase year after year. The financial industry represents a lucrative target for hackers since a successful exploit can net millions of dollars in the form of illicit currency transfers, fraud, stolen personal information, and sensitive financial data. Since consumer confidence and trust is vital to a financial institution's business, a successful hack can have the devastating effect of tarnishing the company's reputation and affecting their bottom line. The organized criminal networks are infamous for delivering targeted exploits and banking trojans. The most common solutions to these exploits in use today involves some form of signature-based detection. In signature-based detection, an antivirus (AV) program takes samples to obtain a signature and then checks to see if it represents a malicious process. The AV program is easily circumvented by minor modifications, such as recompiling, compression, or packing of ransomware to change its signature. This slight change of ransomware signature hampers a computer system's ability to effectively handle zero day threats with current AV programs.

The embodiment or embodiments described herein may solve these shortcomings as well as others by proposing an innovative method and system for characterizing malicious behavior as a collection of Application Programming Interface (API) calls that are indicative of malware. This novel solution for malware prevention and characterization does not rely on malware signatures but instead triggers on malware behavior, thus providing a zero day capability not otherwise possible with anti-virus.

The innovative active defense system (ADS) leverages advanced rootkit detection techniques to provide a breadth of security beyond that provided by operating system services, such as those in Windows, Mac, Linux, iOS, and Android. The ADS dynamically generates API hooking code on any API function in the system and identifies malicious payloads by examining specific API calls that are suspicious and once a suspicious chain of API calls has been recognized, the ADS may deny the process the ability to call the API and kill the thread or process making the suspicious API calls. The ADS provides for the identification, protection, detection, and response for software assurance, malware detection, a network's network characterization and dynamic defense, and data's network characterization.

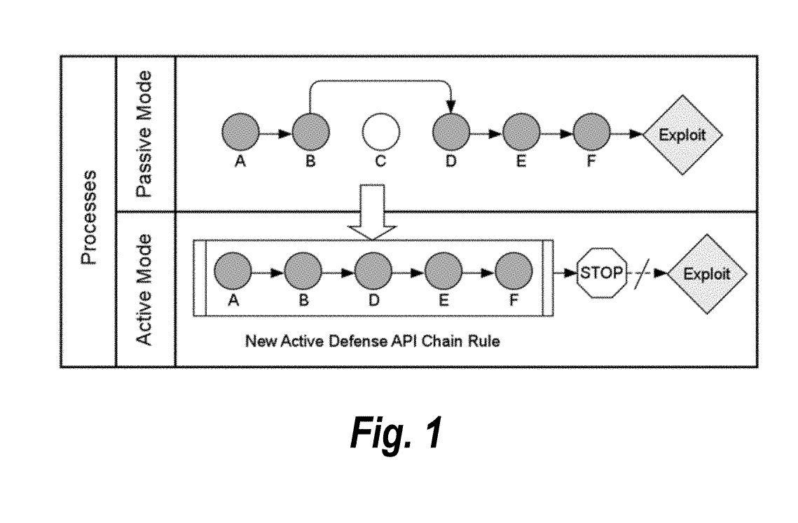

FIG. 1 is a block diagram of an active defense system of a computing system against malware, in accordance with some embodiments.

In some embodiments, the active defense system comprises an intrusion prevention and malware characterization security solution applied in the kernel space of an operating system. The active defense system may operate as both an active service for continuous protection or as a deployable executable for specific forensic characterization tasks. In Active Mode, the active defense system provides intrusion prevention and malware characterization capabilities based on the processes API behavior. A malicious behavior rule is represented as a collection or sequence of APIs. Each API is a state in the behavior rule. As a process calls APIs, each call may advance the state in one or more malicious behavioral rule. If a behavioral rule reaches its final state, it will trigger a set of actions to be executed when the final, triggering API is received. If a process executes a sequence of known malicious behavior, for example a chain of API calls A, B, D, E, and F, the Active Mode may deny the process's call of the API and/or kill the thread or process making the suspicious calls, thus preventing the execution of the exploit. In Passive Mode, the active defense system provides API logging but does not interfere with the process. The Passive Mode is used to provide a log for incident responders to quickly ascertain or characterize the intent of unknown or malicious processes which led to the exploit. For example, by reviewing the log it may be determined that the behavior of the API calls A, B, D, E, and F led to the exploit. Furthermore, this information may be used by internal incident responders to deploy safeguards to the rest of the enterprise as an Active Mode API behavioral rule. For example, in the event a machine is exploited, these integrated logs are immediately available to quickly analyze the malware's behavior. The information from the logs allows a new Active Defense API Chain Rule to be created and deployed to protect the entire enterprise. Typically an enterprise has to wait until the vendor, for example Microsoft, gives the enterprise a defense against the malware. With ADS, larger enterprises can handle zero day attacks without having to wait for the vendor provided defense. If ADS agents are deployed in the enterprise, the enterprise lists of malicious API Chains may be updated to defend against the new threat.

In some embodiments, the ADS comprises a set of rules to identify malicious payloads by examining specific API calls for suspicious behaviors. The ADS may be configured to exclude applications from API monitoring on a rule by rule basis. The client component, which is the core of the host intrusion prevention system, is the DLL which allows the ADS to load it into any application memory space (for maximum effect). The ADS defends against traditional and non-traditional attack vectors because of its ability to monitor all API calls and flag according to signatures that specify behavioral heuristics. Furthermore, the ADS comprises advanced self-protection features that prevent the disabling, deleting, and/or modifying of the ADS's binaries and processes. This monitored information is critical to malware analysis and the rapid implementation of safeguards.

In some embodiments, the log from the Passive Mode is scanned/monitored using machine learning and artificial intelligence for any outliers which may be indicative of a malicious process. If a malicious process is identified, a new Active Defense API Chain Rule may be automatically created and deployed to protect the entire enterprise.

In some embodiments, the ADS comprises white lists which exempts certain processes. For example, Adobe Acrobat uses for updating a beacon out to the internet using an older API call which may also be indicative of some malware. Therefore, the Adobe Acrobat update process may be put on the ADS white list to allow the running of the process without interference by the ADS.

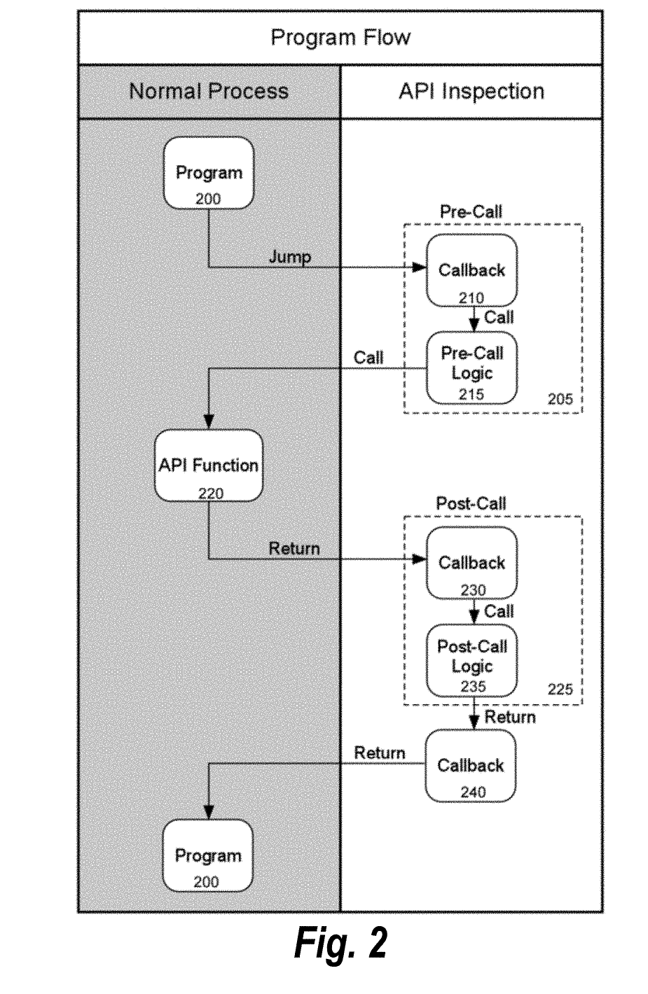

FIG. 2 is a block diagram of an inspection of an API call of the active defense system of the computing system, in accordance with some embodiments.

In some embodiments, the active defense system comprises the inspection of a process/program's API calls. Preselected security related API calls or hooked API calls are hooked for inspection. In a hooked API inspection, Program 200 calls the hooked API and jumps to a Pre-Call 205 process. The Pre-Call 205 process comprises a Callback 210 and Pre-Call Logic 215. The Pre-Call Logic 215 may comprise a check for known or suspicious API behavior. After the Pre-Call Logic 215, a call to the original API Function 220 is made and in some embodiments, the process proceeds back to the Program 200. In other embodiments though, a return is made to a Post-Call 225 process. The Post-Call 225 process comprises a Callback 230 and Post-Call Logic 235. After the Post-Call Logic 235, a return to the Callback 240 is made followed by a return to the Program 200.

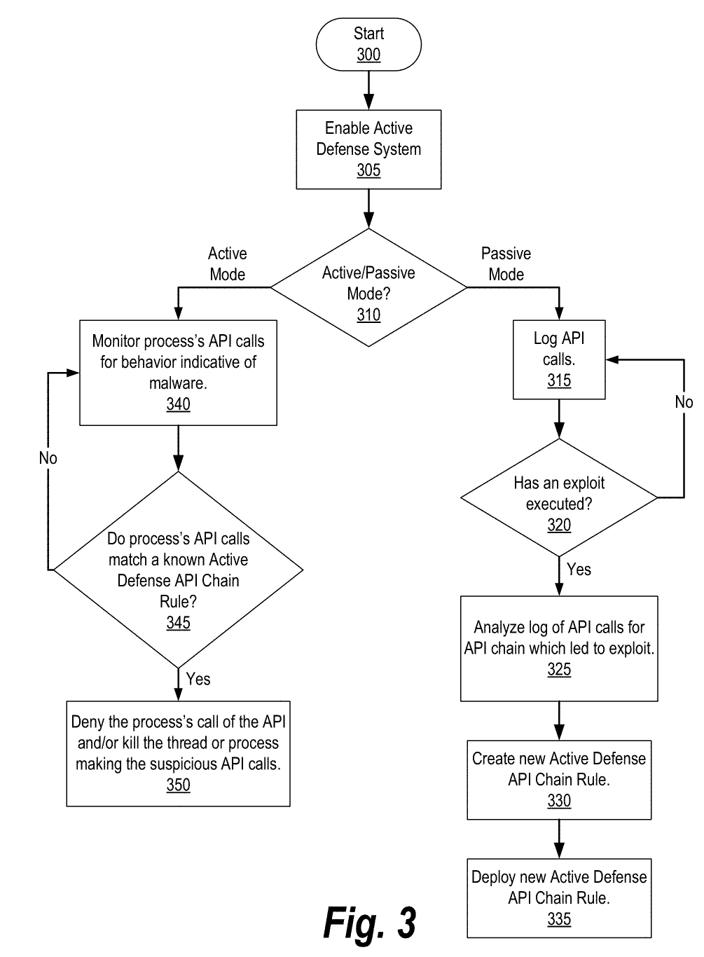

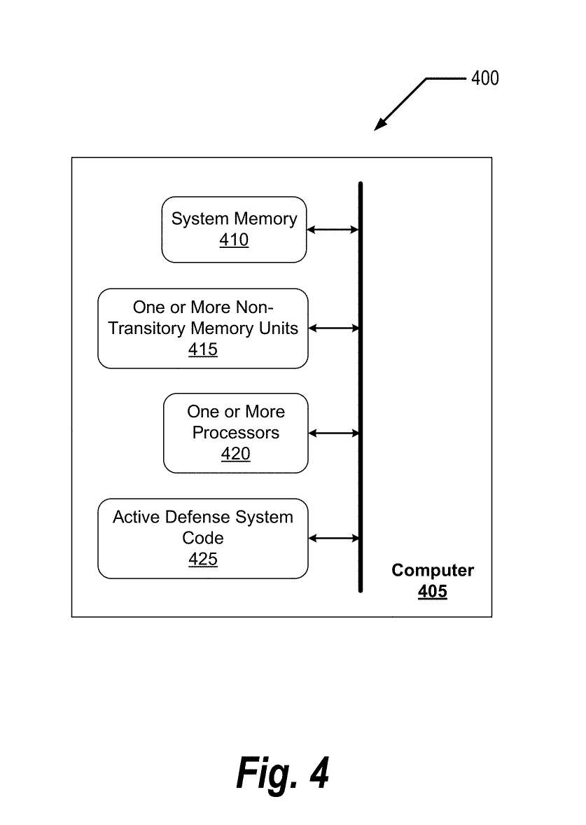

FIG. 3 is a flow diagram illustrating a method for the active defense of a computing system against malware, in accordance with some embodiments. In some embodiments, the method illustrated in FIG. 3 may be performed by one or more of the systems illustrated in FIG. 1, FIG. 2, and FIG. 4.

In some embodiments, a method for the active defense of a computing system against malware begins at 300, whereupon, at block 305, an Active Defense System is enabled. The ADS may be enabled both as an active operating system service for continuous protection or as a deployable executable for specific forensic characterization tasks. At decision 310, a determination is made whether the ADS is in an Active Mode or a Passive Mode. If the ADS is in Passive Mode, decision 310 branches to the “Passive Mode” branch where, at block 315, the ADS creates a log of API calls. In some embodiments, the ADS logging of API calls comprises logging only hooked API calls. Next, at decision 320, a determination is made whether an exploit has executed on the computing system. If an exploit has executed, decision 320 branches to the “yes” branch where, at block 325, the log of API calls is analyzed for the API chain which led to the exploit. After analysis, at block 330, a new Active Defense API Chain Rule is created for the API chain which led to the exploit and at block 335, the new Active Defense API Chain Rule is deployed to protect the entire enterprise. Returning to decision 320, if an exploit has not executed, decision 320 branches to the “no” branch, whereupon processing again continues at block 315.

Returning to decision 310, if the ADS is in Active Mode, decision 310 branches to the “Active Mode” branch where, at block 340, the ADS monitors the process's API calls for behavior indicative of malware. At decision 345, a determination is made whether the process's API calls match one of the known Active Defense API Chain Rules. If the process's API calls do match one of the known Active Defense API Chain Rules, decision 345 branches to the “yes” branch where, at block 350, the ADS denies the process's call of the API and/or kills the thread or process making the suspicious API calls in order to prevent the execution of the exploit. Returning to decision 345, if the process's API calls do not match one of the known Active Defense API Chain Rules, decision 345 branches to the “no” branch, whereupon processing again continues at block 340.

FIG. 4 is a block diagram of an apparatus for the active defense of a computing system against malware, in accordance with some embodiments.

In some embodiments, an apparatus 400 for the active defense of a computing system against malware comprises a computer or server 405. The computer 405 comprises system memory 410, one or more non-transitory memory units 415, one or more processors 420, and an active defense system (ADS) code or program 425. Executing the ADS code, results in a determination whether the ADS is in an Active Mode or a Passive Mode. If the ADS is in Passive Mode, the ADS creates a log of API calls. In some embodiments, the ADS logging of API calls comprises logging only hooked API calls. Next, a determination is made whether an exploit has executed on the computing system. If an exploit has executed, the log of API calls is analyzed for the API chain which led to the exploit. After analysis, a new Active Defense API Chain Rule is created for the API chain which led to the exploit and the new Active Defense API Chain Rule is deployed to protect the entire enterprise. If an exploit has not executed, the ADS continues to create a log of API calls. If the ADS is in Active Mode, the ADS monitors the process's API calls for behavior indicative of malware. Next, a determination is made whether the process's API calls comprise an Active Defense API Chain Rule. If the process's API calls do comprise an Active Defense API Chain Rule, the ADS denies the process's call of the API and/or kills the thread or process making the suspicious API calls in order to prevent the execution of the exploit. If the process's API calls do not comprise an Active Defense API Chain Rule, the ADS continues to monitor the process's API calls for behavior indicative of malware.

Some embodiments described herein relate to a computer storage product with one or more non-transitory memory units having instructions or computer code thereon for performing various computer-implemented operations. The one or more memory units are non-transitory in the sense that they do not include transitory propagating signals per se (e.g., a propagating electromagnetic wave carrying information on a transmission medium such as space or a cable). The one or more memory units and computer code (also can be referred to as code) may be those designed and constructed for the specific purpose or purposes. Examples of one or more memory units include, but are not limited to: magnetic storage media such as hard disks, floppy disks, and magnetic tape; optical storage media such as Compact Disc/Digital Video Discs (CD/DVDs), Compact Disc-Read Only Memories (CD-ROMs), and holographic devices; magneto-optical storage media such as optical disks; carrier wave signal processing modules; and hardware devices that are specially configured to store and execute program code, such as Application-Specific Integrated Circuits (ASICs), Programmable Logic Devices (PLDs), Read-Only Memory (ROM), and Random-Access Memory (RAM) devices.

Examples of computer code include, but are not limited to, micro-code or micro-instructions, machine instructions, such as produced by a compiler, code used to produce a web service, and files containing higher-level instructions that are executed by a computer using an interpreter. For example, embodiments may be implemented using Java, C++, or other programming languages (e.g., object-oriented programming languages) and development tools. Additional examples of computer code include, but are not limited to, control signals, encrypted code, and compressed code.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

The benefits and advantages that may be provided by the present invention have been described above with regard to specific embodiments. These benefits and advantages, and any elements or limitations that may cause them to occur or to become more pronounced are not to be construed as critical, required, or essential features of any or all of the claims. As used herein, the terms “comprises,” “comprising,” or any other variations thereof, are intended to be interpreted as non-exclusively including the elements or limitations which follow those terms. Accordingly, a system, method, or other embodiment that comprises a set of elements is not limited to only those elements, and may include other elements not expressly listed or inherent to the claimed embodiment.

While the present invention has been described with reference to particular embodiments, it should be understood that the embodiments are illustrative and that the scope of the invention is not limited to these embodiments. Many variations, modifications, additions and improvements to the embodiments described above are possible. It is contemplated that these variations, modifications, additions and improvements fall within the scope of the invention as detailed within the following claims.

1. A method for defending a computing system against malware, the method comprising:
(a) determining which mode an active defense system is enabled;
(b) if the determination made in step (a), above, is that the active defense system is set to a passive mode, then using the active defense system to log API calls;
(i) determining whether an exploit has executed on the computing system;
(ii) if the determination made in step (b)(i), above, is that the exploit has not executed on the computing system, then continue using the active defense system to log API calls; and
(iii) if the determination made in step (b)(i), above, is that the exploit has executed on the computing system, then using the active defense system to analyze the log of API calls to determine API chain which resulted in the exploit and creating a new active defense API chain rule from the API chain which resulted in the exploit; and
(c) if the determination made in step (a), above, is that the active defense system is set to an active mode, then using the active defense system to monitor process's API calls;
(i) determining whether the process's API calls match one of known active defense API chain rules;
(ii) if the determination made in step (c)(i), above, is that the process's API calls do not match one of the known active defense API chain rules, then continue using the active defense system to monitor the process's API calls; and
(iii) if the determination made in step (c)(i), above, is that the process's API calls do match one of the known active defense API chain rules, then using the active defense system to deny the process's API call and/or kill the process whose API calls match one of the known active defense API chain rules.

2. The method of claim 1, wherein the method further comprises adding the new active defense API chain rule to the known active defense API chain rules.

3. The method of claim 1, wherein the method further comprises using the active defense system to prevent disabling, deleting, and/or modifying binaries and processes of the active defense system.

4. The method of claim 1, wherein using the active defense system to log API calls comprises logging only hooked API calls.

5. The method of claim 1, wherein using the active defense system to monitor the process's API calls comprises advancing a state of one or more API chain rules of the known API chain rules.

6. The method of claim 1, wherein determining whether the process's API calls match one of the known active defense API chain rules comprises checking whether one of the one or more known API chain rules has reached a final state.

7. The method of claim 1, wherein an API chain rule of the known API chain rules comprises a collection or sequence of APIs indicative of malware.

8. A method for defending a computing system against malware, the method comprising:
(a) using an active defense system to log API calls;
(b) determining whether an exploit has executed on the computing system;
(c) if the determination made in step (b), above, is that the exploit has not executed on the computing system, then continue using the active defense system to log API calls; and
(d) if the determination made in step (b), above, is that the exploit has executed on the computing system, then using the active defense system to analyze the log of API calls to determine API chain which resulted in the exploit and creating a new active defense API chain rule from the API chain which resulted in the exploit.

9. The method of claim 8, wherein the method further comprises adding the new active defense API chain rule to known active defense API chain rules.

10. The method of claim 8, wherein using the active defense system to log API calls comprises logging only hooked API calls.

11. A method for defending a computing system against malware, the method comprising:
(a) using the active defense system to monitor process's API calls;
(b) determining whether the process's API calls match one of known active defense API chain rules;
(c) if the determination made in step (b), above, is that the process's API calls do not match one of the known active defense API chain rules, then continue using the active defense system to monitor the process's API calls; and
(d) if the determination made in step (b), above, is that the process's API calls do match one of the known active defense API chain rules, then using the active defense system to deny the process's API call and/or kill the process whose API calls match one of the known active defense API chain rules.

12. The method of claim 11, wherein using the active defense system to monitor the process's API calls comprises advancing a state of one or more API chain rules of the known API chain rules.

13. The method of claim 11, wherein determining whether the process's API calls match one of the known active defense API chain rules comprises checking whether one of the one or more known API chain rules has reached a final state.

14. The method of claim 11, wherein an API chain rule of the known API chain rules comprises a collection or sequence of APIs indicative of malware.

15. A non-transitory computer-readable storage medium containing instructions that if executed enables a computing system to:
(a) determine which mode an active defense system is enabled;
(b) if the determination made in step (a), above, is that the active defense system is set to a passive mode, then use the active defense system to log API calls;
(i) determine whether an exploit has executed on the computing system;
(ii) if the determination made in step (b)(i), above, is that the exploit has not executed on the computing system, then continue using the active defense system to log API calls; and
(iii) if the determination made in step (b)(i), above, is that the exploit has executed on the computing system, then use the active defense system to analyze the log of API calls to determine API chain which resulted in the exploit and create a new active defense API chain rule from the API chain which resulted in the exploit; and
(c) if the determination made in step (a), above, is that the active defense system is set to an active mode, then use the active defense system to monitor process's API calls;
(i) determine whether the process's API calls match one of known active defense API chain rules;
(ii) if the determination made in step (c)(i), above, is that the process's API calls do not match one of the known active defense API chain rules, then continue using the active defense system to monitor the process's API calls; and
(iii) if the determination made in step (c)(i), above, is that the process's API calls do match one of the known active defense API chain rules, then use the active defense system to deny the process's API call and/or kill the process whose API calls match one of the known active defense API chain rules.

16. The non-transitory computer-readable storage medium of claim 15, further comprising instructions that if executed enable the computing system to use the active defense system to prevent disabling, deleting, and/or modifying binaries and processes of the active defense system.

17. The non-transitory computer-readable storage medium of claim 15, further comprising instructions that if executed enable the computing system to add the new active defense API chain rule to the known active defense API chain rules.

18. The non-transitory computer-readable storage medium of claim 15, wherein using the active defense system to log API calls comprises logging only hooked API calls.

19. The non-transitory computer-readable storage medium of claim 15, wherein using the active defense system to monitor the process's API calls comprises advancing a state of one or more API chain rules of the known API chain rules.

20. The non-transitory computer-readable storage medium of claim 15, wherein determining whether the process's API calls match one of the known active defense API chain rules comprises checking whether one of the one or more known API chain rules has reached a final state.

21. The non-transitory computer-readable storage medium of claim 15, wherein an API chain rule of the known API chain rules comprises a collection or sequence of APIs indicative of malware.

22. A non-transitory computer-readable storage medium containing instructions that if executed enables a computing system to:
(a) use the active defense system to log API calls;
(b) determine whether an exploit has executed on the computing system;
(c) if the determination made in step (b), above, is that the exploit has not executed on the computing system, then continue using the active defense system to log API calls; and
(d) if the determination made in step (b), above, is that the exploit has executed on the computing system, then use the active defense system to analyze the log of API calls to determine API chain which resulted in the exploit and create a new active defense API chain rule from the API chain which resulted in the exploit.

23. The non-transitory computer-readable storage medium of claim 22, further comprising instructions that if executed enable the computing system to add the new active defense API chain rule to known active defense API chain rules.

24. The non-transitory computer-readable storage medium of claim 22, wherein using the active defense system to log API calls comprises logging only hooked API calls.

25. A non-transitory computer-readable storage medium containing instructions that if executed enables a computing system to:
(a) use the active defense system to monitor process's API calls;
(b) determine whether the process's API calls match one of known active defense API chain rules;
(c) if the determination made in step (b), above, is that the process's API calls do not match one of the known active defense API chain rules, then continue using the active defense system to monitor the process's API calls; and
(d) if the determination made in step (b), above, is that the process's API calls do match one of the known active defense API chain rules, then use the active defense system to deny the process's API call and/or kill the process whose API calls match one of the known active defense API chain rules.

26. The non-transitory computer-readable storage medium of claim 25, wherein using the active defense system to monitor the process's API calls comprises advancing a state of one or more API chain rules of the known API chain rules.

27. The non-transitory computer-readable storage medium of claim 25, wherein determining whether the process's API calls match one of the known active defense API chain rules comprises checking whether one of the one or more known API chain rules has reached a final state.

28. The non-transitory computer-readable storage medium of claim 25, wherein an API chain rule of the known API chain rules comprises a collection or sequence of APIs indicative of malware.

29. A computing system comprising:
at least one storage device containing instructions that if executed enables the computing system to:
(a) determine which mode an active defense system is enabled;
(b) if the determination made in step (a), above, is that the active defense system is set to a passive mode, then use the active defense system to log API calls;
(i) determine whether an exploit has executed on the computing system;
(ii) if the determination made in step (b)(i), above, is that the exploit has not executed on the computing system, then continue using the active defense system to log API calls; and
(iii) if the determination made in step (b)(i), above, is that the exploit has executed on the computing system, then use the active defense system to analyze the log of API calls to determine API chain which resulted in the exploit and create a new active defense API chain rule from the API chain which resulted in the exploit; and
(c) if the determination made in step (a), above, is that the active defense system is set to an active mode, then use the active defense system to monitor process's API calls;
(i) determine whether the process's API calls match one of known active defense API chain rules;
(ii) if the determination made in step (c)(i), above, is that the process's API calls do not match one of the known active defense API chain rules, then continue using the active defense system to monitor the process's API calls; and
(iii) if the determination made in step (c)(i), above, is that the process's API calls do match one of the known active defense API chain rules, then use the active defense system to deny the process's API call and/or kill the process whose API calls match one of the known active defense API chain rules.

30. The computing system of claim 29, further comprising instructions that if executed enable the computing system to add the new active defense API chain rule to the known active defense API chain rules.

31. The computing system of claim 29, further comprising instructions that if executed enable the computing system to use the active defense system to prevent disabling, deleting, and/or modifying binaries and processes of the active defense system.

32. The computing system of claim 29, wherein using the active defense system to log API calls comprises logging only hooked API calls.

33. The computing system of claim 29, wherein using the active defense system to monitor the process's API calls comprises advancing a state of one or more API chain rules of the known API chain rules.

34. The computing system of claim 29, wherein determining whether the process's API calls match one of the known active defense API chain rules comprises checking whether one of the one or more known API chain rules has reached a final state.

35. The computing system of claim 29, wherein an API chain rule of the known API chain rules comprises a collection or sequence of APIs indicative of malware.

36. A computing system comprising:
at least one storage device containing instructions that if executed enables the computing system to:
(a) use the active defense system to log API calls;
(b) determine whether an exploit has executed on the computing system;
(c) if the determination made in step (b), above, is that the exploit has not executed on the computing system, then continue using the active defense system to log API calls; and
(d) if the determination made in step (b), above, is that the exploit has executed on the computing system, then use the active defense system to analyze the log of API calls to determine API chain which resulted in the exploit and create a new active defense API chain rule from the API chain which resulted in the exploit.

37. The computing system of claim 36, further comprising instructions that if executed enable the computing system to add the new active defense API chain rule to known active defense API chain rules.

38. The computing system of claim 36, wherein using the active defense system to log API calls comprises logging only hooked API calls.

39. A computing system comprising:
at least one storage device containing instructions that if executed enables the computing system to:
(a) use the active defense system to monitor process's API calls;
(b) determine whether the process's API calls match one of known active defense API chain rules;
(c) if the determination made in step (b), above, is that the process's API calls do not match one of the known active defense API chain rules, then continue using the active defense system to monitor the process's API calls; and
(d) if the determination made in step (b), above, is that the process's API calls do match one of the known active defense API chain rules, then use the active defense system to deny the process's API call and/or kill the process whose API calls match one of the known active defense API chain rules.

40. The computing system of claim 39, wherein using the active defense system to monitor the process's API calls comprises advancing a state of one or more API chain rules of the known API chain rules.

41. The computing system of claim 39, wherein determining whether the process's API calls match one of the known active defense API chain rules comprises checking whether one of the one or more known API chain rules has reached a final state.

42. The computing system of claim 39, wherein an API chain rule of the known API chain rules comprises a collection or sequence of APIs indicative of malware.
